(19) United States
(12) Patent Application Publication
(10) Pub. No.: US 2016/0026969 A1
(43) Pub. Date: Jan. 28, 2016

(54) METHODS AND DEVICES OF SENDING AND RECEIVING ITEM INFORMATION

(71) Applicant: Xiaomi Inc., Beijing (CN)

(72) Inventors: Wei Wang, Beijing (CN); Xiaodan Zhang, Beijing (CN); Mingyang Yu, Beijing (CN); Baiming Ma, Beijing (CN)

(21) Appl. No.: 14/690,476

(22) Filed: Apr. 20, 2015

Related U.S. Application Data
(63) Continuation of application No. PCT/CN2014/091758, filed on Nov. 20, 2014.

(30) Foreign Application Priority Data
Jul. 23, 2014 (CN) 201410354449.8

(51) Int. Cl. G06Q 10/08

(52) U.S. Cl. CPC G06Q 10/087

(57) ABSTRACT

The present disclosure relates to methods and devices of sending and receiving item information. The method of sending item information comprises: acquiring storage information of the article storing device; acquiring item information of items stored in the article storing device according to the storage information, wherein the item information includes at least description information of the item; and sending the item information to a terminal device corresponding to a user. With the present disclosure, a remote viewing and controlling of the article storing device may be achieved.

### CROSS REFERENCE TO RELATED APPLICATIONS

The present application is a Continuation of International Application No. PCT/CN2014/091758, filed on Nov. 20, 2014, which is based upon and claims priority to Chinese Patent Application No. 201410354449.8, filed on Jul. 23, 2014, the entire contents of which are incorporated herein by reference.

### TECHNICAL FIELD

The present disclosure relates to a field of Internet technology, and more particularly, to methods of sending and receiving item information and the devices thereof.

### BACKGROUND

With the improvement of people's living standard, a refrigerator has entered many households, and has become an essential home appliance. Given that the refrigerator has a refrigerating function, a user usually uses the refrigerator to store items. For example, the user buys vegetables, meats, eggs and beverages and other items from a supermarket or a market, and in order to extend the storage time of these items, the user generally puts these items in the refrigerator to store.

However, the user may forget various items stored in the refrigerator so that the storage time of these items stored in the refrigerator becomes too long, thereby resulting in spoiling of the items due to the long storage time, or the user repeatedly purchases certain items in the case of forgetting these items are already stored in the refrigerator.

### SUMMARY

According to a first aspect of embodiments of the present disclosure, there is provided a method of sending item information in a control system, comprising: acquiring storage information of an article storing device; acquiring item information of items stored in the article storing device according to the storage information, wherein the item information includes at least description information of the items; and sending the item information to a terminal device corresponding to a user.

According to a second aspect of embodiments of the present disclosure, there is provided a method of receiving item information in a terminal device, comprising: receiving item information of items stored in an article storing device, wherein the item information includes at least description information of the items; and displaying the item information to a user.

According to a third aspect of embodiments of the present disclosure, there is provided a control system, comprising: a processor; and a memory for storing instructions executable by the processor, wherein the processor is configured to perform: acquiring storage information of an article storing device; acquiring item information of items stored in the article storing device according to the storage information, wherein the item information includes at least description information of the items; and sending the item information to a terminal device corresponding to a user.

The technical solutions provided by the embodiments of the present disclosure may include the following advantageous effects:

By acquiring information on an item stored in the article storing device, the information on the item including at least description information of the item; and sending the information on the item to the mobile terminal corresponding to the user, a remote viewing and controlling of the article storing device may be achieved, thereby avoiding the item stored in the article storing device is forgotten by the user.

It is to be understood that both the foregoing general description and the following detailed description are exemplary and explanatory only and are not restrictive of the present disclosure.

### BRIEF DESCRIPTION OF THE DRAWINGS

The accompanying drawings are used to provide further illustration of the present disclosure, and constitute a part of the present application, rather than limiting the present disclosure. In the drawings:

FIG. 1 is a flow chart of a method of sending item information according to an exemplary embodiment.

FIG. 2 is a flow chart of a method of receiving item information according to an exemplary embodiment.

FIG. 3A is a flow chart of a method of sending item information according to an exemplary embodiment.

FIG. 3B is a schematic diagram of a first kind of interior image according to an exemplary embodiment.

FIG. 3C is a schematic diagram of a second kind of interior image according to an exemplary embodiment.

FIG. 3D is a schematic diagram of a third kind of interior image according to an exemplary embodiment.

FIG. 4A is a block diagram of an apparatus of sending item information according to an exemplary embodiment.

FIG. 4B is a structurally block diagram of a first acquisition module according to an exemplary embodiment.

FIG. 5 is a block diagram of an apparatus of receiving item information according to an exemplary embodiment.

FIG. 6 is a structurally block diagram of a control system according to an exemplary embodiment.

FIG. 7 is a structurally block diagram of a terminal device according to an exemplary embodiment.

Explicit embodiments of the present disclosure that have been illustrated in the above accompany drawings will be described in more detail hereinafter. These accompany drawings and literal description are by no means intended to limit the scope of the idea of the present disclosure, but to explain the concept of the present disclosure to those skilled in the art with reference to particular embodiments.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

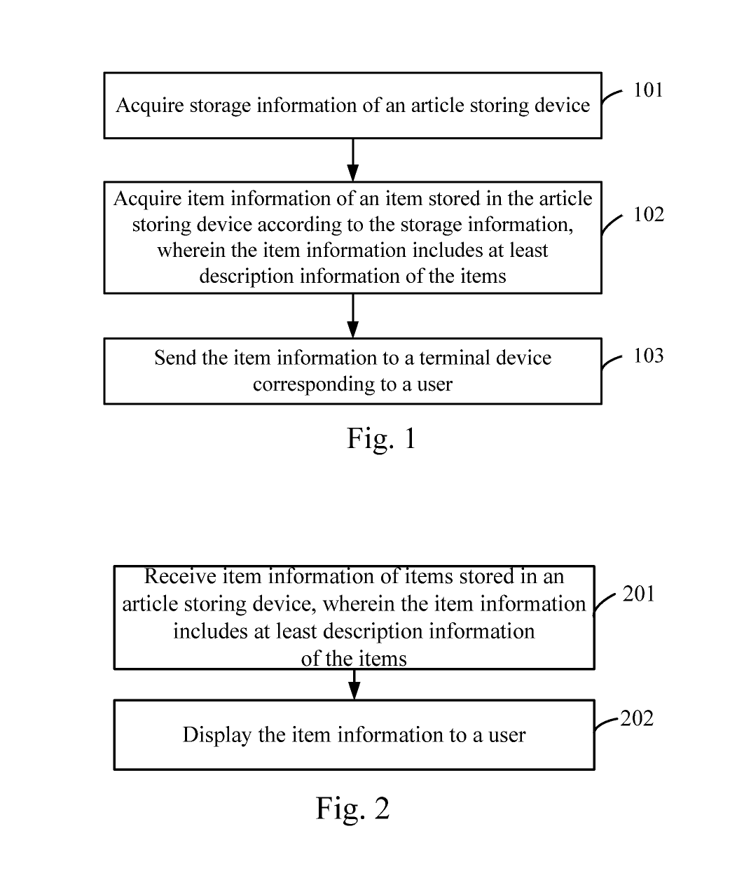

FIG. 1 is a flow chart of a method of sending item information according to an exemplary embodiment. As shown in FIG. 1, the method of sending item information is used at an article storing device, comprising the following steps.

In Step 101, storage information of the article storing device is acquired.

In Step 102, item information of items stored in the article storing device is acquired according to the storage information, wherein the item information includes at least description information of the items.

In Step 103, the item information is sent to a terminal device corresponding to a user.

In the embodiments of the present disclosure, by acquiring the item information of the items stored in the article storing device, wherein the item information includes at least the description information of the items, and by sending the item information to the terminal device corresponding to the user, the article storing device may be remotely viewed and controlled, thereby avoiding the case of the items stored in the article storing device being forgotten by the user.

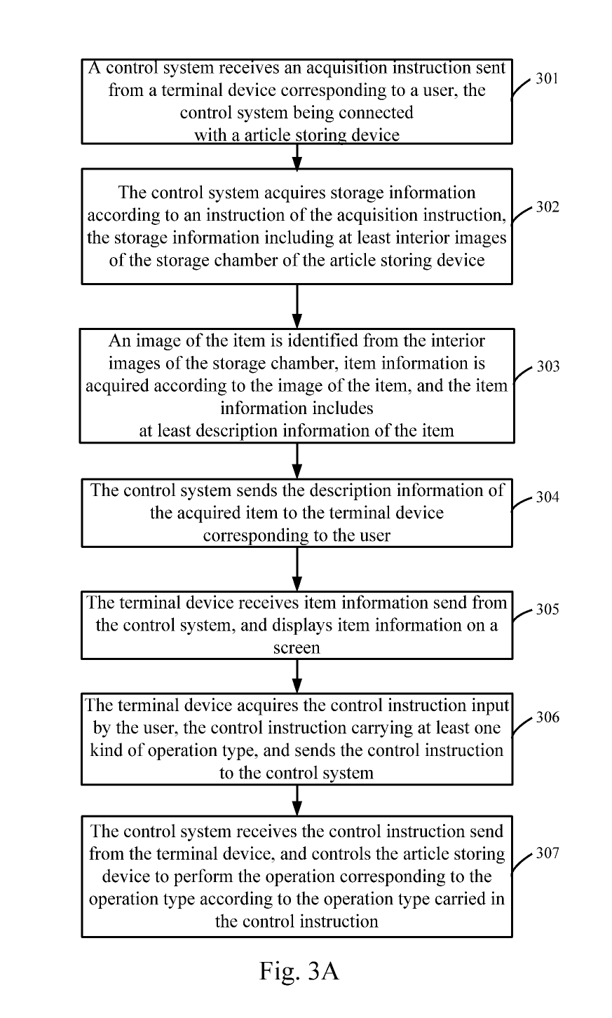

FIG. 2 is a flow chart of a method of receiving item information according to an exemplary embodiment. As shown in FIG. 2, the method of receiving item information is used at a terminal device, comprising the following steps.

In Step 201, item information of items stored in an article storing device is received, wherein the item information including at least description information of the items.

In Step 202, the item information is displayed to a user.

In the embodiments of the present disclosure, by receiving the item information of the items stored in the article storing device, by displaying the item information to the user, by acquiring the control instruction inputted by the user, wherein the control instruction carries an operation type, and by sending the control instruction to the article storing device, so as to control the article storing device to perform an operation corresponding to the operation type, the article storing device may be remotely viewed and controlled, thereby avoiding the case of the items stored in the article storing device being forgotten by the user.

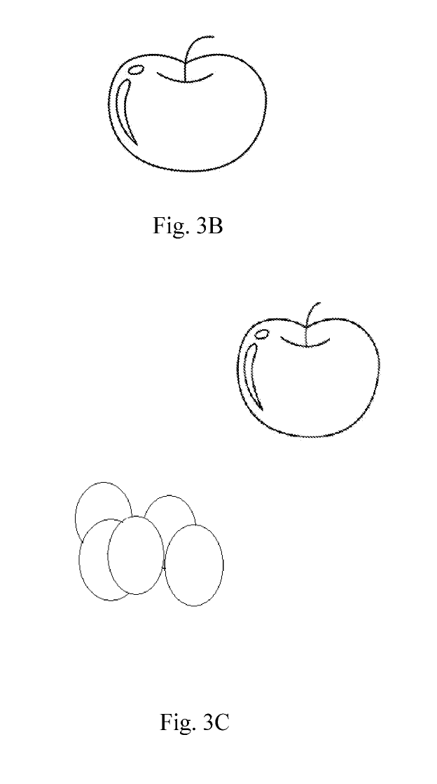

Referring to FIG. 3A, the embodiments of the present disclosure provide a method of sending item information, comprising the following steps.

In Step 301, a control system receives an acquisition instruction sent by a terminal device corresponding to a user, and the control system is connected with an article storing device.

The article storing device may be a refrigerator, a freezer or a wardrobe, and the like. Sometimes, the user needs to acquire item information of items stored in the article storing device. Taking the refrigerator as an example, when the user buys products in a supermarket, the user needs to know the items that are already stored in the refrigerator, so as to avoid repurchase of the same items. At this time, the user may trigger the user's terminal device to send the acquisition instruction to the control system connected with the refrigerator, and request the control system to acquire the item information in the refrigerator.

In the article storing device, different storage chambers may store different kinds of items, for example, some of the storage chambers are used to store vegetables, and some of the storage chambers are used to store fruits. Sometimes, the user may only need to know the item information in some storage chambers. At this time, the user may input an identification of the storage chamber to be acquired to the terminal device, and the terminal device carries the identification of the storage chamber to be acquired in the acquisition instruction, and then sends the acquisition instruction. For example, when the user buys vegetables in a market, the user may need to know only the item information in a storage chamber for storing vegetables, the user may input the identification of the storage chamber for storing vegetables to the terminal device, the terminal device carries the identification of the storage chamber for storing vegetables in the acquisition instruction, and then sends the acquisition instruction.

Alternatively, the control system may be located within the article storing device, and may also be located outside the article storing device. When the control system is located outside the article storing device, the control system and the article storing device may be connected by a home network, the home network may be wired network, wireless network, Bluetooth or infrared, and the like. When the control system is located outside the article storing device, the control system may be a router. When the control system is located within the article storing device, the control system may be an integrated control unit in the article storing device. Moreover, it is also possible that a part of the control system is located within the article storing device, while the other parts of the control system is located outside the article storing device.

In Step 302, the control system acquires the storage information according to an instruction of the acquisition instruction.

The storage information includes information associated with the article storing device. For example, the storage information may include interior images of the storage chamber of the article storing device, or include status information of the article storing device, or include the interior images and the status information of the storage chamber of the article storing device, and the like.

The control system includes at least one camera, and the camera included in the control system is installed in the storage chamber of the article storing device. When the control system is located outside of the article storing device, the camera and other parts (such as a processor or a memory) of the control system may be connected with each other via the home network. Preferably, the cameras are respectively installed at four corner positions of each storage chamber, so as to photograph images of the storage chamber at various angles and full range.

This step may be that the control system receives the acquisition instruction sent by the terminal device, and controls the camera to photograph the storage chamber of the article storing device according to the instruction of the acquisition instruction, so as to acquire the interior images of the storage chamber of the article storing device.

Preferably, the status information of the article storing device comprises at least a temperature, humidity and bacteria density of the storage chamber of the article storing device. The control system further comprises at least a temperature sensor, a humidity sensor and a bacterial density detector. The temperature sensor may be installed in the storage chamber of the article storing device, the humidity sensor may be installed in the storage chamber of the article storing device, or the bacterial density detector may be installed in the storage chamber of the article storing device, or any two of the temperature sensor, the humidity sensor and the bacterial density detector may be installed in the storage chamber of the article storing device, or all of the temperature sensor, the humidity sensor and the bacterial density detector may be installed in the storage chamber of the article storing device. Preferably, one temperature sensor, one humidity sensor and one bacterial density detector are respectively installed in each storage chamber of the article storing device, so as to acquire the status information of the article storing device respectively. When the control system is located outside the article storing device, the other parts of the control system may be connected with the temperature sensor, the humidity sensor and the bacterial density detector via the home network.

This step may be that the control system controls the temperature sensor to monitor the temperature in the storage chamber, controls the humidity sensor to monitor the humidity in the storage chamber, controls the bacterial density detector to monitor the bacterial density in the storage chamber, and acquires the temperature in the storage chamber monitored by the temperature sensor, the humidity in the storage chamber monitored by the humidity sensor and the bacterial density in the storage chamber monitored by the bacterial density detector according to the instruction of the acquisition instruction.

Preferably, if the acquisition instruction also carries the identification of the storage chamber to be acquired, then the step of acquiring of the storage information of the storage chamber to be acquired according to the identification of the storage chamber to be acquired may be implemented as follows.

The control system controls the camera located in the storage chamber to be acquired to photograph the storage chamber to be acquired, and obtains the interior images of the storage chamber to be acquired according to the identification of the storage chamber to be acquired carried by the acquisition instruction.

For example, the control system receives the identification of the storage chamber for storing vegetables carried by the acquisition instruction, and then controls the camera in the storage chamber for storing vegetables to photograph the storage chamber for storing vegetables, and obtains the interior images of the storage chamber for storing vegetables.

Preferably, if the status information of the storage chamber to be acquired is further required to be acquired, the status information may also be acquired as follows.

The control system controls the temperature sensor located in the storage chamber to be acquired to monitor the temperature in the storage chamber to be acquired, controls the humidity sensor located in the storage chamber to be acquired to monitor the humidity in the storage chamber to be acquired, and controls the bacterial density sensor located in the storage chamber to be acquired to monitor the bacterial density in the storage chamber to be acquired according to the identification of the storage chamber to be acquired carried by the acquisition instruction.

Preferably, before proceeding to this step, when a door of the article storing device is opened, the control system controls the camera in the storage chamber of the article storing device to photograph the storage chamber of the article storing device, and acquires the photographed interior images. Preferably, the control system further comprises a memory for storing the photographed interior images in the memory.

Correspondingly, this step may be that the interior images of the storage chamber of the article storing device last photographed, which are stored in the memory, are acquired according to the instruction of the acquisition instruction.

In Step 303, an image of the item is identified from the interior images of the storage chamber, the item information is acquired according to the image of the item, and the item information includes at least description information of the item.

The description information of the items includes name and/or introduction information of the item, and the like. Before proceeding to this step, a corresponding correlation table between standard item image and the description information is stored in the memory, the corresponding correlation table between the standard item image and the description information is used for storing at least one standard item image and description information corresponding to respective item.

This step may includes the following substeps: the image of the item is identified from the interior images of the storage chamber, similarity between the image of the item and respective standard item image in the corresponding correlation table between the standard item image and the description information is calculated, the standard item image having the highest similarity with the image of the item is selected, the corresponding description information is acquired from the corresponding correlation table between the standard item image and the description information according to the selected standard item image, and the acquired description information serves as the item description information.

For example, in the corresponding correlation table between the standard item image and the description information shown in table 1, the corresponding correlation table includes standard item images 1, 2 and 3, the standard item images 1, 2 and 3 are an apple image, a pear image and a peach image, respectively, and the description information corresponding to the standard item images 1, 2 and 3 respectively are an apple, a pear and a peach respectively.

The image of the item as shown in FIG. 3B is identified from the interior images of the article storing device, and the identified image of the item is an apple image. The similarity between the image of the item and the standard item images 1, 2 and 3 in the table 1 is calculated respectively, wherein the standard item image 1 has the highest similarity compared with the image of the item. According to the standard item image 1, the description information “apple” corresponding to the standard item image 1 is acquired from the table 1, and the “apple” serves as the description information of the item.

Table 1

TABLE 1

| standard item image | item description information |
|---|---|
| standard item image 1 | apple |
| standard item image 2 | pear |
| standard item image 3 | peach |

Preferably, the item information further comprises freshness of the items, and the freshness is used to represent degree of how fresh the items are. In Step 303, the freshness of the items may also be acquired, which comprises the following two steps.

In the first step, freshness of the items stored in the article storing device at the first time is acquired, wherein the first time is a time when the item is put into the article storing device or a time when the freshness of the item is last calculated.

When the item is put into the article storing device, the current time serves as the first time of the item and a default freshness serves as the freshness of the items at the first time, and the description information of the items, the first time of the items and the freshness of the items at the first time are stored in the corresponding relationship among the item description information, the first time and the freshness. Otherwise, when the freshness of some items is calculated, the first time of the items and the freshness of the items at the first time stored in the corresponding relationship among the item description information, the first time and the freshness are updated into the current time and the current calculated freshness. The default freshness may be the value of 100, 95 or 90, etc.

In the first step, freshness of the items at the first time is acquired from the corresponding relationship among the item description information, the first time and the freshness according to the description information of the items.

In the second step, freshness of the items is calculated according to the current time, the status information, the first time and the freshness of the items at the first time.

The freshness of the items is calculated according to the following formula:

$$X = {X}_{0} - \frac{{t}_{1} - {t}_{0}}{T} * A * B * ( \frac{{T}_{1}}{{T}_{0}} {T}_{c} ) * ( \frac{{H}_{1}}{{H}_{0}} {H}_{c} ) * ( \frac{{P}_{1}}{{P}_{0}} {P}_{c} )$$

In the above described formula, X is the freshness of the items, X₀ is the freshness of the items at the first time, t₁ is the current time, t₀ is the first time, T is a length of an attenuation cycle, A is a freshness attenuation standard value in an attenuation cycle, B is an item attenuation coefficient, T₁ is a temperature of the storage chamber for storing the items, T₀ is an empirical temperature, T_{C} is a temperature coefficient, H₁ is a humidity of the storage chamber for storing the items, H₀ is an empirical humidity, H_{C} is a humidity coefficient, P₁ is a bacteria density of the storage chamber for storing the items, P₀ is an empirical bacteria density, and P_{C} is a bacteria density coefficient.

Herein, A, B, T₀, H₀, P₀, T_{C}, H_{C}, and P_{C} are fixed values set in advance. And preferably, may also be preset by the user.

Further, in the corresponding relationship among the item description information, the first time and the freshness, the freshness of the items at the first time is updated as the calculated freshness, and the first time of the items is updated into the current time.

It should be noted that when the user opens the door of the article storing device, the user may take out the items from the article storing device or put in new items into the article storing device, and then close the door of the article storing device. Therefore, every time the door of the article storing device is closed after being opened, the corresponding relationship among the item description information, the first time and the freshness needs to be updated. The process is as follows:

(1) When it is detected the door of the article storing device is closed, the storage chamber of the article storing device is photographed, and the interior images of the storage chamber are obtained.

When the user closes the door of the article storing device, the control system detects that the door of the article storing device is closed, and controls the camera in the storage chamber to photograph the storage chamber, wherein the photographed images serves as the interior images of the storage chamber.

(2) Description information and position information of the items stored in the article storing device when the door of the article storing device is last closed are acquired.

This step may be that the description information and the position information of the items stored in the article storing device when the door of the article storing device is closed latest are acquired from the corresponding relationship between the description information and the position information.

For example, as shown in FIG. 3C, the items stored in the article storing device when the door of the article storing device is last closed comprise an apple and eggs. The position information of the apple is located in the northeast corner of the storage chamber, and the position information of the eggs is located in the southeast corner of the storage chamber.

(3) Items newly put into the article storing device and items taken out by the user are acquired according to the interior images of the storage chamber and the description information and the position information of the items stored in the article storing device when the door of the article storing device is last closed.

This step may be that the description information and the position information of each item in the current article storing device are acquired according to the interior images of the storage chamber, the description information and the position information of each item in the current article storing device are compared respectively with the description information and the position information of the items stored in the article storing device when the door of the article storing device is last closed to obtain the items newly put into the article storing device and the items taken out from the article storing device.

For example, as shown in FIG. 3D, the description information of the items in the current article storing device acquired according to the interior images of the storage chamber includes: information respectively representing an apple, strawberries and grapes. Moreover, the position information of the apple is the northeast corner of the storage chamber, the position information of the strawberries is southeast corner of the storage chamber, and the position information of the grapes is the northwest corner of the storage chamber. The description information and the position information of each item in the current article storing device are compared with the description information and the position information of the items stored in the article storing device when the door of the article storing device is last closed so as to confirm that the items newly put into the article storing device are the strawberries and the grapes, and the items taken out by the user are eggs.

(4) The current time is determined as a first time of the items newly put into the article storing device, and freshness of the items newly put into the article storing device is set as default freshness.

(5) The item description information, the first time and the freshness at the first time of the items newly put into the article storing device are stored in the corresponding relationship among the item description information, the first time and the freshness.

(6) The item description information, the first time and the freshness of the items taken out are deleted from the corresponding relationship among the item description information, the first time and the freshness.

Further, the description information and the position information of the items newly put into the article storing device are stored in the corresponding relationship between the description information and the position information, and the description information and the position information of the items taken out are deleted from the corresponding relationship between the description information and the position information.

It should be noted that after the items are put into the article storing device, the freshness of the items needs to be calculated at a preset interval, and the updating of the corresponding relationship among the item description information, the first time and the freshness may be as follows.

Firstly, an item, which has a time interval between the first time thereof and the current time reaches a preset time, is acquired periodically from the corresponding relationship among the item description information, the first time and the freshness.

Secondly, status information of the current article storing device is acquired, and the freshness of the current item is calculated according to the current time, the status information and the first time of the item, and the freshness of the item at the first time.

This step may be that the temperature sensor, the humidity sensor and/or the bacterial density detector located in the article storing device are controlled to collect the status information of the item, and then the freshness of the current item is calculated according to the above described formula (1).

Finally, in the corresponding relationship among the item description information, the first time and the freshness, the first time of the item is updated as the current time, and the freshness of the item is updated as the freshness of the current item.

Preferably, after the freshness of the current item is calculated, the item with freshness lower than a preset threshold value may also be acquired, prompt information is sent to the terminal device corresponding to the user, wherein the prompt information carries at least prompt content and the description information of the acquired item, for example, the prompt content may be “Hello, the freshness of the apple in the article storing device is lower than the preset threshold value, and might be deteriorated, please take an action timely”.

In Step 304, the control system sends the description information of the acquired item to the terminal device corresponding to the user.

Preferably, the control system may also send the interior images of the storage chamber of the article storing device to the terminal device corresponding to the user.

Preferably, in the embodiments of the present disclosure, the control system may also periodically acquire the item information stored in the article storing device, and send the acquired item information to the terminal device corresponding to the user, so as to inform the user of the state of each item in the article storing device. That is, the storage information is periodically acquired, and then the process proceeds to the above described Steps 303 and 304 to acquire the item information stored in the article storing device and send the acquired information to the terminal device corresponding to the user.

Preferably, the control system may firstly send the item information to a router by wireless network, Bluetooth or infrared, and the like, and then the router sends the item information to the terminal device corresponding to the user via wired or wireless network.

In Step 305, the terminal device receives the item information sent by the control system, and displays the item information on a screen.

Sometimes the user is not at home, but the user wants to be able to drink iced beverages after getting home. At this time, the user may control the article storing device to ice the item, or if the user wants to directly use a thawed item after getting home, the user may control the article storing device to thaw the item.

The user sets a control instruction, which carries at least one kind of operation type, and then inputs the control instruction to the terminal device. The operation type may be an ice operation or a thaw operation.

Preferably, the control instruction carries an identification of the storage chamber to be controlled.

In Step 306, the terminal device acquires the control instruction inputted by the user, which carries at least one kind of operation type, and then sends the control instruction to the control system.

In Step 307, the control system receives the control instruction sent by the terminal device, and controls the article storing device to perform the operation corresponding to the operation type according to the operation type carried in the control instruction.

This step may be that if the control instruction carries the operation type and the identification of the storage chamber to be controlled, the article storing device is controlled to perform the operation corresponding to the operation type to the storage chamber to be controlled according to the operation type and the identification of the storage chamber to be controlled.

In the article storing device, the items such as the beverages and the likes are stored in a storage chamber, and in general, it is only required to ice the storage chamber, therefore, ice operation type and the identification of the storage chamber may be previously stored in the corresponding relationship between the operation type and the identification of the storage chamber; and in the article storing device, the items required to be refrigerated storage are stored in a storage chamber for freezing, in generally, the storage chamber only needs to be thawed.

This step may be that the identification of the storage chamber corresponding to the operation type is found in the corresponding relationship between the operation type and the default identification of the storage chamber according to the operation type carried in the control instruction, and the article storing device is controlled to perform the operation corresponding to the operation type to the storage chamber corresponding to the identification of the storage chamber.

The corresponding relationship between the operation type and the identification of the storage chamber may be configured by a technical person before the article storing device leaves the factory, and may also be set by the user.

For example, the default storage chamber corresponding to the ice operation type is storage chamber 1, the default storage chamber corresponding to the thaw operation type is storage chamber 2, and then the ice operation type and the identification ID 1 of the storage chamber 1 are stored in the corresponding relationship between the operation type and the default identification of the storage chamber, the thaw operation type and the identification ID 2 of the storage chamber 2 are stored in the corresponding relationship between the operation type and the default identification of the storage chamber. Assuming that the operation type carried in the control instruction is the ice operation type, the corresponding identification ID 1 of the storage chamber 1 is acquired from the corresponding relationship between the operation type and the identification of the storage chamber according to the ice operation type, the storage chamber 1 corresponding to the article storing device is controlled to perform the ice operation corresponding to the ice operation type.

In the embodiments of the present disclosure, the control system connected with the article storing device receives the acquisition instruction sent by the terminal device, acquires the storage information including at least the interior images of the storage chamber of the article storing device as well as the temperature value, the humidity value and the bacterial density value; acquires the item information stored in the article storing device, including at least the item description information as well as the freshness of the item stored in the article storing device, and sends the item information to the terminal device corresponding to the user, thus the article storing device may be remotely viewed and controlled, thereby avoiding the item stored in the article storing device being forgotten by the user.

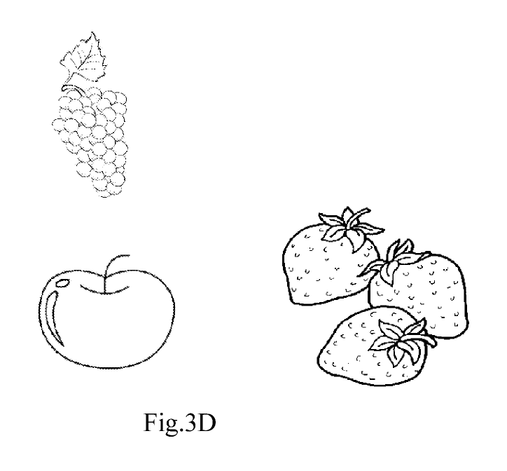

Based on the same technical conception, the embodiments of the present disclosure also provide an apparatus of sending item information, as shown in FIG. 4A. The apparatus comprises: a first acquisition module 401 configured to acquire storage information; second acquisition module 402 configured to acquire item information of items stored in the article storing device according to the storage information, wherein the item information including at least description information of the items; and a sending module 403 configured to send the item information to a terminal device corresponding to a user.

Referring to FIG. 4B, the first acquisition module 401 may include a processor and a camera. The camera is located in a storage chamber of the article storing device.

The processor is configured to control the camera to photograph the storage chamber of the article storing device, so as to obtain interior images of the storage chamber of the article storing device.

Preferably, the storage information further comprises status information of the article storing device, wherein the status information comprises at least one of a temperature, humidity and bacteria density of the storage chamber of the article storing device.

Preferably, the first acquisition module 401 further comprises: at least one of a temperature sensor, a humidity sensor and a bacterial detector. The temperature sensor, the humidity sensor and the bacterial detector are located in the storage chamber of the article storing device.

The processor is also configured to control the humidity sensor and/or the bacterial detector to monitor the temperature, the humidity and/or the bacteria density of the storage chamber.

Preferably, the first acquisition module 401 may further comprise a memory, and the processor is also configured to store the interior images, the temperature, the humidity and/or the bacteria density of the storage chamber in the memory.

Preferably, a second acquisition module 402 comprises: an identification unit configured to identify images of the items from the interior images of the storage chamber; and a first acquisition unit configured to acquire the description information of the items according to the images of the items.

Preferably, the item information further comprises freshness of the items.

The second acquisition module 402 further comprises: a second acquisition unit configured to acquire freshness of the items stored in the article storing device at a first time, wherein the first time is a time when the item is put into the article storing device or a time when the freshness of the items is calculated latest; and a calculation unit configured to calculate freshness of the item according to a current time, the status information, the first time and the freshness of the items at the first time.

Preferably, the second acquisition module 402 further comprises: an updating unit configured to update the freshness of the items at the first time as a calculated freshness, and update the first time of the items as the current time.

Preferably, the second acquisition module 402 further comprises: a photographing unit configured to photograph the storage chamber of the article storing device to obtain the interior images of the storage chamber when detecting that a door of the article storing device is closed; a third acquisition unit configured to acquire the description information and the position information of the items stored in the article storing device when the door of the article storing device is last closed; a fourth acquisition unit configured to acquire items newly put into the article storing device according to the interior images of the storage chamber and the description information and the position information of the items stored in the article storing device when the door of the article storing device is last closed; and a determining unit configured to determine the current time as a first time of the items newly put into the article storing device, and set the freshness of the items newly put into the article storing device at the first time as default freshness.

Preferably, the calculation unit is used for:

calculating the freshness of the items according to the following formula:

$$X = {X}_{0} - \frac{{t}_{1} - {t}_{0}}{T} * A * B * ( \frac{{T}_{1}}{{T}_{0}} {T}_{c} ) * ( \frac{{H}_{1}}{{H}_{0}} {H}_{c} ) * ( \frac{{P}_{1}}{{P}_{0}} {P}_{c} )$$

In the above described formula, X is the freshness of the items, X₀ is the freshness of the items at the first time, t₁ is the current time, t₀ is the first time, T is a length of an attenuation cycle, A is a freshness attenuation standard value in an attenuation cycle, B is an item attenuation coefficient, T₁ is a temperature of the storage chamber for storing the items, T₀ is an empirical temperature, T_{C} is a temperature coefficient, H₁ is a humidity of the storage chamber for storing the items, H₀ is an empirical humidity, H_{C} is a humidity coefficient, P₁ is a bacteria density of the storage chamber for storing the items, P₀ is an empirical bacteria density, and P_{C} is a bacteria density coefficient.

Preferably, the first acquisition module 401 comprises: a fifth acquisition unit configured to receive an acquisition instruction sent by the terminal device corresponding to the user, and acquire the storage information according to an instruction of the acquisition instruction; or a sixth acquisition unit configured to acquire the storage information periodically.

Preferably, the sending module 403 comprises: a selection unit configured to select the items, freshness of which is lower than a preset threshold value; and a sending unit configured to send the information on the selected items to the terminal device corresponding to the user.

In the embodiments of the present disclosure, by receiving the acquisition instruction sent by the terminal device, acquiring the storage information, the storage information includes at least the interior images of the storage chamber of the article storing device, acquiring the item information stored in the article storing device according to the storage information, the item information including at least the description information of the items, and sending the item information to the terminal device corresponding to the user, thus the article storing device may be remotely viewed and controlled, thereby avoiding the item stored in the article storing device being forgotten by the user.

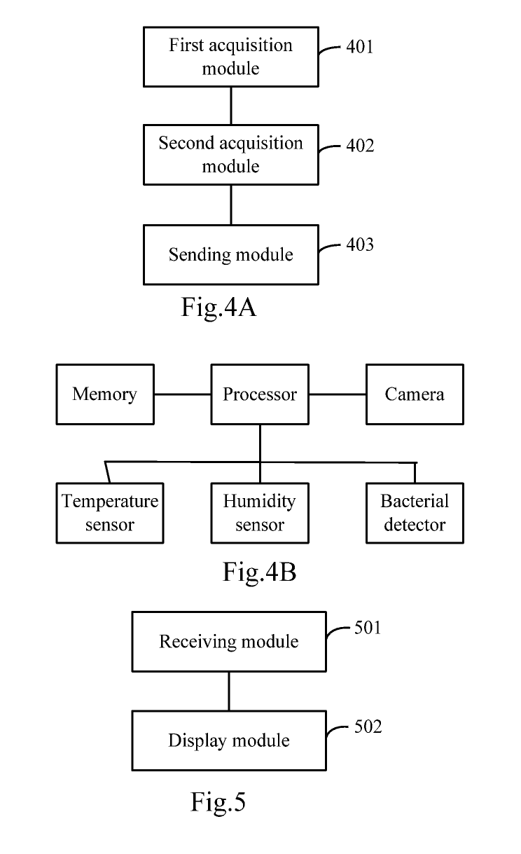

Based on the same technical conception, the embodiments of the present disclosure also provide an apparatus of receiving item information, as shown in FIG. 5. The apparatus comprises a receiving module 501 configured to receive item information of items stored in an article storing device, wherein the item information including at least description information of the items; and a display module 502 configured to display the item information to a user.

Preferably, the apparatus further comprises: a second acquisition module configured to acquire an acquisition instruction inputted by the user, and send the acquisition instruction to the article storing device, so that the article storing device acquires and sends the item information of the items stored in the article storing device.

Preferably, the apparatus further comprises: a first acquisition module configured to acquire a control instruction inputted by the user, wherein the control instruction carries an operation type; and a sending module configured to send the control instruction to the article storing device, so as to control the article storing device to perform an operation corresponding to the operation type.

In the embodiments of the present disclosure, by receiving the item information stored in the article storing device, displaying the item information to the user, by acquiring the control instruction inputted by the user, wherein the control instruction carries an operation type, and by sending the control instruction to the article storing device, so as to control the article storing device to perform the operation corresponding to the operation type, the article storing device may be remotely viewed and controlled, thereby avoiding the item stored in the article storing device being for gotten by the user.

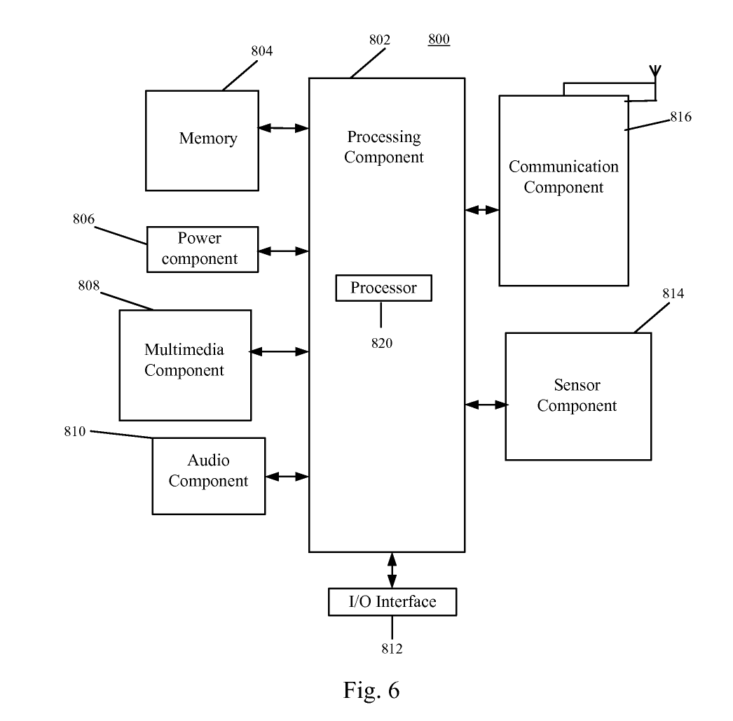

FIG. 6 is a block diagram showing a control system 800 for sending item information according to an exemplary embodiment. For example, the control system 800 may be a router, a home appliance controller, an office appliance controller, a control unit integrated in the article storing device, a control unit integrated in a smart robot and the like.

Referring to FIG. 6, the control system 800 may include one or more of the following components: a processing component 802, a memory 804, a power component 806, a multimedia component 808, an audio component 810, an input/output (I/O) interface 812, a sensor component 814, and a communication component 816.

The processing component 802 usually controls overall operations of the control system 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the control system 800. Examples of such data include instructions for any application or method operated on the control system 800, contact data, phonebook data, messages, pictures, videos, etc. The memory 804 may be implemented using any type of volatile or non-volatile memory device or combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the control system 800. The power component 806 may include a power management system, one or more power sources, and other components associated with the generation, management, and distribution of power in the control system 800.

The multimedia component 808 includes a screen providing an output interface between the control system 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, slips, and gestures on the touch panel. The touch sensors may not only sense a boundary of a touch or slip action, but also sense a period of time and a pressure associated with the touch or slip action. In some embodiments, the multimedia component 808 includes a plurality of cameras. The cameras may receive an external multimedia datum while the control system 800 is in an operation mode, such as a photographing mode or a video mode. Each of the cameras may be a fixed optical lens system or have focus and optical zoom capability. For example, the cameras are installed in the storage chamber of the article storing device. When the control system is located outside of the article storing device, the camera and other parts (such as a processor or a memory) of the control system may be connected with each other via the home network. Preferably, the cameras are respectively installed at four corner positions of each storage chamber, so as to photograph images of the storage chamber at various angles and full range.

The audio component 810 is configured to output and/or input audio signals. For example, the audio component 810 includes a microphone (MIC) configured to receive an external audio signal when the control system 800 is in an operation mode, such as a call mode, a recording mode, and a voice identification mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, a button, and the like. The button may include, but not limited to, a home button, a volume button, a starting button, and a locking button.

The sensor component 814 includes one or more sensors to provide status assessments of various aspects of the control system 800. For example, the sensor component 814 may comprise at least a temperature sensor, a humidity sensor and a bacterial density detector. The temperature sensor may be installed in the storage chamber of the article storing device, the humidity sensor may be installed in the storage chamber of the article storing device, or the bacterial density detector may be installed in the storage chamber of the article storing device, or any two of the temperature sensor, the humidity sensor and the bacterial density detector may be installed in the storage chamber of the article storing device, or all of the temperature sensor, the humidity sensor and the bacterial density detector may be installed in the storage chamber of the article storing device. Preferably, one temperature sensor, one humidity sensor and one bacterial density detector are respectively installed in each storage chamber of the article storing device, so as to acquire the status information of the article storing device respectively. When the control system is located outside the article storing device, the other parts of the control system may be connected with the temperature sensor, the humidity sensor and the bacterial density detector via the home network.

The communication component 816 is configured to facilitate communication, wired or wirelessly, between the control system 800 and other devices (such as the terminal device 900). The control system 800 can access a wireless network based on a communication standard, such as WiFi, 2G, or 3G, or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the control system 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above method.

In exemplary embodiments, there is also provided a non-transitory computer readable storage medium including instructions, such as included in the memory 804, executable by the processor 820 in the control system 800, for performing the above method. For example, the non-transitory computer-readable storage medium may be a ROM, a random access memory (RAM), a CD-ROM, a magnetic tape, a floppy disc, an optical data storage device, and the like.

A non-transitory computer readable storage medium, when instructions in the storage medium are executed by the processor of a control system, the control system may execute a method of sending item information, the method comprises acquiring storage information of an article storing device; acquiring item information of items stored in the article storing device according to the storage information, wherein the item information including at least description information of the item; and sending the item information to a terminal device corresponding to a user.

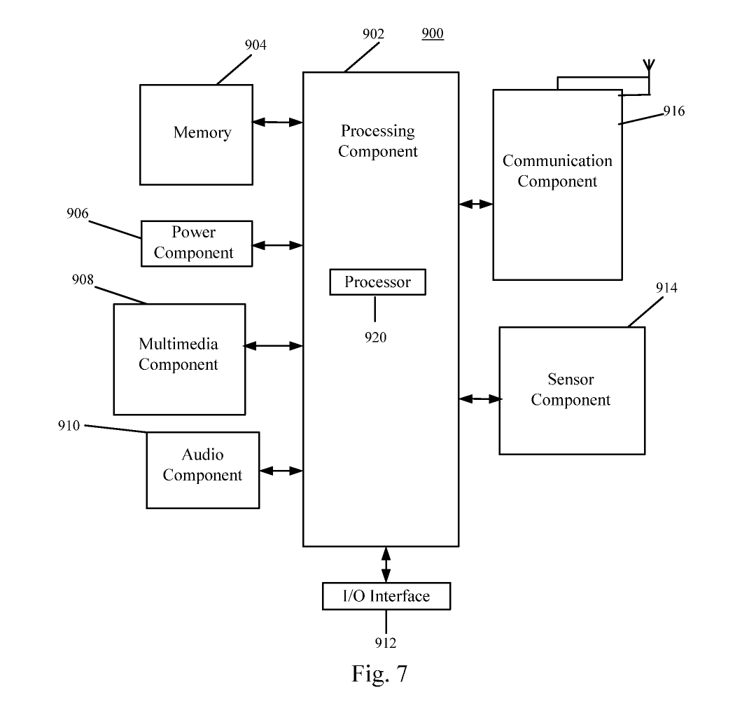

FIG. 7 is a block diagram showing a terminal device 900 for receiving item information according to an exemplary embodiment. For example, the terminal device 900 may be a mobile phone, a computer, a digital broadcast terminal, a messaging device, a gaming console, a tablet, a medical device, exercise equipment, a personal digital assistant and the like.

Referring to FIG. 7, the terminal device 900 may include one or more of the following components: a processing component 902, a memory 904, a power component 906, a multimedia component 908, an audio component 910, an input/output (I/O) interface 912, a sensor component 914, and a communication component 916.

The processing component 902 usually controls overall operations of the terminal device 900, such as the operations associated with display, telephone calls, data communications, camera operations, and recording operations. The processing component 902 may include one or more processors 920 to execute instructions to perform all or part of the steps in the above described methods. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 is configured to store various types of data to support the operation of the terminal device 900. Examples of such data include instructions for any application or method operated on the terminal device 900, contact data, phonebook data, messages, pictures, videos, etc. The memory 904 may be implemented using any type of volatile or non-volatile memory device or combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the terminal device 900. The power component 906 may include a power management system, one or more power sources, and other components associated with the generation, management, and distribution of power in the terminal device 900.

The multimedia component 908 includes a screen providing an output interface between the terminal device 900 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, slips, and gestures on the touch panel. The touch sensors may not only sense a boundary of a touch or slip action, but also sense a period of time and a pressure associated with the touch or slip action. In some embodiments, the multimedia component 908 includes a front camera and/or a rear camera. The front camera and/or the rear camera may receive an external multimedia datum while the terminal device 900 is in an operation mode, such as a photographing mode or a video mode. Each of the front camera and the rear camera may be a fixed optical lens system or have focus and optical zoom capability.

The audio component 910 is configured to output and/or input audio signals. For example, the audio component 910 includes a microphone (MIC) configured to receive an external audio signal when the terminal device 900 is in an operation mode, such as a call mode, a recording mode, and a voice identification mode. The received audio signal may be further stored in the memory 904 or transmitted via the communication component 916. In some embodiments, the audio component 910 further includes a speaker to output audio signals.

The I/O interface 912 provides an interface between the processing component 902 and peripheral interface modules, such as a keyboard, a click wheel, a button, and the like. The button may include, but not limited to, a home button, a volume button, a starting button, and a locking button.

The sensor component 914 includes one or more sensors to provide status assessments of various aspects of the terminal device 900. For instance, the sensor component 914 may detect an open/closed status of the terminal device 900, relative positioning of components, e.g., the display and the keyboard, of the terminal device 900, a change in position of the terminal device 900 or a component of the terminal device 900, a presence or absence of user contact with the terminal device 900, an orientation or an acceleration/deceleration of the terminal device 900, and a change in temperature of the terminal device 900. The sensor component 914 may include a proximity sensor configured to detect the presence of nearby objects without any physical contact. The sensor component 914 may also include a light sensor, such as a CMOS or CCD image sensor, for use in imaging applications. In some embodiments, the sensor component 914 may also include an accelerometer sensor, a gyroscope sensor, a magnetic sensor, a pressure sensor, or a temperature sensor.

The communication component 916 is configured to facilitate communication, wired or wirelessly, between the terminal device 900 and other devices (such as the control system 800). The terminal device 900 can access a wireless network based on a communication standard, such as Wi-Fi, 2G, or 3G, or a combination thereof. In one exemplary embodiment, the communication component 916 receives a broadcast signal or broadcast associated information from an external broadcast management system via a broadcast channel. In one exemplary embodiment, the communication component 916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal device 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above method.

In exemplary embodiments, there is also provided a non-transitory computer readable storage medium including instructions, such as included in the memory 904, executable by the processor 920 in the terminal device 900, for performing the above method. For example, the non-transitory computer-readable storage medium may be a ROM, a random access memory (RAM), a CD-ROM, a magnetic tape, a floppy disc, an optical data storage device, and the like.

A non-transitory computer readable storage medium, when instructions in the storage medium are executed by the processor of a terminal device, the terminal device may execute a method of receiving item information of an article storing device, the method comprises receiving item information of items stored in the article storing device, wherein the item information including at least description information of the item; and displaying the item information to a user.

After considering this description and carrying out the embodiments disclosed herein, those skilled in the art may easily anticipate other implementation aspects of the present disclosure. The present disclosure is meant to cover any variations, usage or adaptive change of these embodiments, and these variations, usage or adaptive change follow general concept of the present disclosure and include the common knowledge or the customary technical means in the technical field that is not disclosed in the present disclosure. The description and embodiments are only exemplary, and the real range and spirit of the present disclosure are defined by the following claims.

It should be understood that the present disclosure is not limited to precise structures that are described above and shown in the accompanying drawings, and may be modified and changed without departing from the range of the present disclosure. The scope of the present disclosure is only defined by the appended claims.

What is claimed is:

1. A method of sending item information in a control system, comprising:
acquiring storage information of an article storing device;
acquiring item information of items stored in the article storing device according to the storage information, wherein the item information includes at least description information of the items; and
sending the item information to a terminal device corresponding to a user.

2. The method according to claim 1, wherein acquiring the item information of the items stored in the article storing device according to the storage information comprising:
identifying images of the items from interior images of the article storing device; and
acquiring the description information of the items according to the images of the items.

3. The method according to claim 1, wherein the storage information further comprises status information of the article storing device; the status information comprises at least a temperature, humidity and bacteria density of storage chambers in the article storing device; and the item information further comprises freshness of the items.

4. The method according to claim 3, wherein acquiring the item information of the items stored in the article storing device according to the storage information further comprises:
acquiring the freshness of the items stored in the article storing device at a first time, wherein the first time is a time when the items are put into the article storing device or a time when the freshness of the items is last calculated; and
calculating the freshness of the items according to a current time, the status information, the first time and the freshness of the items at the first time.

5. The method according to claim 4, further comprising:
updating the freshness of the items at the first time as a calculated freshness; and
updating the first time of the items as the current time.

6. The method according to claim 4, further comprising:
photographing the article storing device to obtain the interior images of the storage chambers when detecting that a door of the article storing device is closed;
acquiring the description information and position information of the items stored in the article storing device when the door of the article storing device is last closed;
acquiring items newly put into the article storing device according to the interior images of the article storing device and the description information and the position information of the items stored in the article storing device when the door of the article storing device is last closed;
determining the current time as a first time of the items newly put into the article storing device; and
setting freshness of the items newly put into the article storing device at the first time as a default freshness.

7. The method according to claim 4, wherein calculating the freshness of the items according to the current time, the status information, the first time and the freshness of the items at the first time comprising:
calculating the freshness of the items according to a formula,
$$X = {X}_{0} - \frac{{t}_{1} - {t}_{0}}{T} * A * B * ( \frac{{T}_{1}}{{T}_{0}} {T}_{c} ) * ( \frac{{H}_{1}}{{H}_{0}} {H}_{c} ) * ( \frac{{P}_{1}}{{P}_{0}} {P}_{c} ) ,$$
where, X is the freshness of the items, X₀ is the freshness of the items at the first time, t₁ is the current time, t₀ is the first time, T is a length of an attenuation cycle, A is a freshness attenuation standard value in the attenuation cycle, B is an item attenuation coefficient, T₁ is a temperature of the storage box for storing the items, T₀ is an empirical temperature, T_{C} is a temperature coefficient, H₁ is a humidity of the storage box for storing the items, H₀ is an empirical humidity, H_{C} is a humidity coefficient, P₁ is the bacteria density of the storage box for storing the items, and P₀ is an empirical bacteria density, and P_{C} is a bacteria density coefficient.

8. The method according to claim 7, wherein acquiring the storage information comprising:
receiving an acquisition instruction sent by the terminal device corresponding to the user; and
acquiring the storage information according to an instruction from the acquisition instruction.

9. The method according to claim 7, wherein acquiring the storage information comprising: acquiring the storage information periodically.

10. The method according to claim 1, wherein sending the item information to the terminal device corresponding to the user comprising:
selecting the items, freshness of which is lower than a preset threshold value; and
sending the information on the selected items to the terminal device corresponding to the user.

11. A method of receiving item information in a terminal device, comprising:
receiving item information of items stored in an article storing device, wherein the item information includes at least description information of the items; and
displaying the item information to a user.

12. The method according to claim 11, further comprising:
acquiring an acquisition instruction inputted by the user; and
sending the acquisition instruction to the article storing device, so that the article storing device acquires and sends the item information of the items stored in the article storing device.

13. The method according to claim 11, further comprising:
acquiring a control instruction inputted by the user, wherein the control instruction carries an operation type; and
sending the control instruction to the article storing device, so as to control the article storing device to perform an operation corresponding to the operation type.

14. A control system, comprising:
a processor; and
a memory for storing instructions executable by the processor,
wherein the processor is configured to perform:
acquiring storage information of an article storing device;
acquiring item information of items stored in the article storing device according to the storage information, wherein the item information includes at least description information of the items; and
sending the item information to a terminal device corresponding to a user.

15. The device according to claim 14, wherein the storage information further comprises status information of the article storing device; the status information comprises at least a temperature, humidity and bacteria density of storage chambers in the article storing device; and the item information further comprises freshness of the items.

16. The device according to claim 15, wherein acquiring the item information of the items stored in the article storing device according to the storage information further comprises:
acquiring the freshness of the items stored in the article storing device at a first time, wherein the first time is a time when the items are put into the article storing device or a time when the freshness of the items is last calculated; and
calculating the freshness of the items according to a current time, the status information, the first time and the freshness of the items at the first time.

17. The device according to claim 16, wherein the processor is further configured to perform:
updating the freshness of the items at the first time as a calculated freshness; and
updating the first time of the items as the current time.

18. The device according to claim 16, wherein the processor is further configured to perform:
photographing the article storing device to obtain the interior images of the storage chambers when detecting that a door of the article storing device is closed;
acquiring the description information and position information of the items stored in the article storing device when the door of the article storing device is last closed;
acquiring items newly put into the article storing device according to the interior images of the article storing device and the description information and the position information of the items stored in the article storing device when the door of the article storing device is last closed;
determining the current time as a first time of the items newly put into the article storing device; and
setting freshness of the items newly put into the article storing device at the first time as a default freshness.

19. The device according to claim 16, wherein calculating the freshness of the items according to the current time, the status information, the first time and the freshness of the items at the first time comprising:
calculating the freshness of the items according to a formula,
$$X = {X}_{0} - \frac{{t}_{1} - {t}_{0}}{T} * A * B * ( \frac{{T}_{1}}{{T}_{0}} {T}_{c} ) * ( \frac{{H}_{1}}{{H}_{0}} {H}_{c} ) * ( \frac{{P}_{1}}{{P}_{0}} {P}_{c} ) ,$$
where, X is the freshness of the items, X₀ is the freshness of the items at the first time, t₁ is the current time, t₀ is the first time, T is a length of an attenuation cycle, A is a freshness attenuation standard value in the attenuation cycle, B is an item attenuation coefficient, T₁ is a temperature of the article storing device for storing the items, T₀ is an empirical temperature, T_{C} is a temperature coefficient, H₁ is a humidity of the article storing device for storing the items, H₀ is an empirical humidity, H_{C} is a humidity coefficient, P₁ is the bacteria density of the article storing device for storing the items, and P₀ is an empirical bacteria density, and P_{C} is a bacteria density coefficient.

20. The device according to claim 19, wherein acquiring the storage information comprising:
receiving an acquisition instruction sent by the terminal device corresponding to the user; and
acquiring the storage information according to an instruction from the acquisition instruction.

21. The device according to claim 14, wherein sending the item information to the terminal device corresponding to the user comprising:
selecting the items, freshness of which is lower than a preset threshold value; and
sending the information on the selected items to the terminal device corresponding to the user.
